(19) United States
(12) Patent Application Publication
(10) Pub. No.: US 2018/0191236 A1
(43) Pub. Date: Jul. 5, 2018

(54) Filter Device for Power Converters with Silicon Carbide Mosfets

(71) Applicant: General Electric Company, Schenectady, NY (US)

(72) Inventors: Robert Gregory Wagoner, Roanoke, VA (US); Warren Mark Blewitt, Rugby (GB)

(21) Appl. No.: 15/398,866

(22) Filed: Jan. 5, 2017

(51) Int. Cl. H02M 1/12; H02M 5/458; H02M 3/335

(52) U.S. Cl. CPC H02M 1/12; H02M 3/33546; H02M 5/458

(57) ABSTRACT

Filter devices for use in power conversion systems utilizing silicon carbide MOSFETs are provided. A power conversion system can include a power converter configured to convert power from a first power to a second power. The second power can have at least one different characteristic from the first power. The power converter can include one or more silicon carbide MOSFET. The power conversion system can further include a filter device configured to filter at least a portion of one or more switching harmonics from power converted by the power converter.

### FIELD

The present subject matter relates generally to power systems, and more particularly to filtering devices for use in power systems including power converters utilizing silicon carbide switching devices.

### BACKGROUND

Power converters can be used in a variety of energy storage and delivery systems, such as wind turbine power systems, solar power systems, energy storage systems, and uninterruptible power supply systems. Power converters are often used to convert power from a first form of power to a second form of power, such as DC to DC, DC to AC, or AC to DC power conversion. In a typical power converter, a plurality of switching devices, such as insulated-gate bipolar transistors (“IGBTs”) or metal-oxide-semiconductor field effect transistors (“MOSFETs”) can be used in electronic circuits, such as half bridge or full-bridge circuits, to convert the power.

Recent developments in switching device technology have allowed for the use of silicon carbide (“SiC”) switching devices, such as SiC MOSFETs, in power converters. Using SiC MOSFETs allows for operation of a power converter at a much higher switching frequency compared to conventional IGBTs. In many applications, it may be desirable to include a filter to filter the power from a power converter due to switching harmonics from the power converter. However, typical filters used with power converters, such as inductor filters, may have high losses when operated at high frequencies or when high frequency content is superimposed on a low frequency fundamental, as an inherent result of the power conversion process when utilizing switching devices. Further, typical filters can overheat when operated at high frequencies.

### BRIEF DESCRIPTION

Aspects and advantages of embodiments of the present disclosure will be set forth in part in the following description, or may be learned from the description, or may be learned through practice of the embodiments.

One example aspect of the present disclosure is directed to a power conversion system. The power conversion system can include a power converter configured to convert power from a first power to a second power. The second power can have at least one different characteristic from the first power. The power converter can include one or more silicon carbide switching devices. The power conversion system can further include a filter device configured to filter at least a portion of one or more switching harmonics from the second power converted by the power converter.

Another example aspect of the present disclosure is directed to a method for providing power. The method can include providing power from a power source to a power converter. The power converter can be configured to convert power from a first power to a second power. The second power can have at least one different characteristic from the first power. The power converter can include one or more silicon carbide switching devices. The method can further include converting the power with the power converter to a converted power. The method can further include filtering the converted power to a filtered power with a filter device. The filter device can be configured to filter at least a portion of one or more switching harmonics from the converted power. The method can further include providing the filtered power to a power delivery point.

Another example aspect of the present disclosure is directed to a wind turbine system. The wind turbine system can include a wind driven generator configured to generate AC power. The wind turbine system can further include a power converter coupled to the generator. The power converter can include a first converter configured to convert AC power to DC power and a second converter configured to convert DC power to AC power. The second converter can include one or more silicon carbide switching devices. The wind turbine system can further include a filter device configured to filter at least a portion of one or more switching harmonics from power converted by the power converter. The filter device can include an inductor. The inductor can include a core element and a coil element. The core element can include a magnetic material. The coil element can include a conductor coiled about at least a portion of the core element.

Variations and modifications can be made to these example aspects of the present disclosure.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example wind turbine system;

FIG. 2 depicts an example power converter according to example aspects of the present disclosure;

FIG. 3 depicts example elements for use in a power converter according to example aspects of the present disclosure;

FIG. 4 depicts an power converter according to example aspects of the present disclosure;

FIG. 5 depicts an example power system according to example aspects of the present disclosure;

FIG. 6 depicts an example filter device according to example aspects of the present disclosure;

FIG. 7 depicts an example filter device according to example aspects of the present disclosure;

FIG. 8 depicts a portion of an example filter device according to example aspects of the present disclosure;

FIG. 9 depicts a power system according to example aspects of the present disclosure;

FIG. 10 depicts a power system according to example aspects of the present disclosure;

FIG. 11 depicts a power system according to example aspects of the present disclosure;

FIG. 12 depicts a power system according to example aspects of the present disclosure;

FIG. 13 depicts a power system according to example aspects of the present disclosure;

FIG. 14 depicts a power system according to example aspects of the present disclosure;

FIG. 15 depicts a power system according to example aspects of the present disclosure; and

FIG. 16 depicts a method according to example aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Example aspects of the present disclosure are directed to power systems for use in converting power converters with SiC MOSFETs. In particular, example aspects of the present disclosure are directed to power converters capable of converting power from a first power to a second power. The second power can have at least one different characteristic from the first power. For example, the first power can be converted from a first voltage to a second voltage, from a first AC power to a second AC power, from an AC power to a DC power, from a DC power to an AC power, or from a first DC power to a second DC power. The power converter can include one or more SiC MOSFETs. For example, a power converter can be a low voltage DC to medium voltage AC converter for use in a wind turbine system, which can include a plurality of DC to DC to AC isolated inverter building blocks. Each DC to DC to AC isolated inverter building block can include one or more SiC MOSFETs. The SiC MOSFETs can be configured to switch at a higher switching frequency than conventional IGBTs. The power system can further include a filter device configured to filter switching harmonics from the power converter.

For example, filter device can include an inductor. The inductor can include a core element and a coil element. The core element can comprise a magnetic material, such as a low loss magnetic core material. The core element can include multiple distributed air gaps in the core, or can include finely ground magnetic material, where the magnetic particles are coated with non-conducting and non-magnetic layers. For example, the core material of the core element can be powdered iron and ferrite. The core element can also include a plurality of legs. For example the core element can be a cut C-core or E-core, which can include a plurality of legs. Further, the legs of a core element can include air gaps. In an embodiment, the core element can include multiple air gaps. Further, the core element can be a laminated core comprising a plurality of laminated layers. For example, each laminated layer can include a magnetic material coated with a non-magnetic and non-conducting material. The core element can include a plurality of laminated layers. For example, a core element can include a plurality of laminated layers with multiple air gaps, and can include wound type laminated unicores.

The coil element of the filter device can be a current carrying conductor, which can be coiled around at least a portion of the core element. The coil element can be a low loss conductor or configuration of current carrying conductors. The coil element can be selected to reduce the resistance of the inductor at high frequencies. In various embodiments, the coil element can include small parallel wires, continuously transposed parallel conductors, Litz wires, or thin layers of foil. The filter device can be used in applications where reduction of harmonic current emissions is required, but without significant attenuation of the current at the desired frequency.

According to example aspects of the present disclosure, the filter device can further include a capacitor. For example, a filter device can include an inductor coupled to the output of a power converter at a first node, with a capacitor coupled to a second node of the inductor. In an embodiment, the capacitor can further be connected to a ground. The second node of the inductor can be coupled to a power delivery point, such as a grid. The filter device can receive a power output from the power converter with a high voltage harmonic content, and can process the power by passing the fundamental frequency with minimal attenuation while more significantly reducing the amplitude of the harmonic frequencies.

According to example aspects of the present disclosure, the power system can further include a cooling device configured to cool the filter device. For example, in an embodiment, the filter device can be convection cooled wherein heat from the filter device dissipates via convection. In other embodiments, the filter device can be cooled by a fan, which can direct airflow onto the filter device, liquid cooled, which can direct a cooling liquid onto the filter device, or evaporation cooled, by providing a phase change fluid to the filter device, which can provide cooling when the phase change fluid changes phases, such as by evaporation.

The filter device of a power system can further include a plurality of inductors. For example, a filter device can include two or more inductors, such as two or more inductors coupled in series. In an embodiment, a filter device can include two or more inductors coupled in parallel. In yet another embodiment, a power system can include a plurality of filter devices, such as a first filter device coupled between a power converter and a power source, and a second filter device coupled between the power converter and a power delivery point.

The power converter in the power system can be a power converter suitable for use in a variety of applications. For example, the power converter can include a two-level power converter. Additionally and/or alternatively, a power converter can be a multi-level power converter, such as a three-level, four-level, five-level, or other multi-level converter. In an embodiment, the power converter can be a power converter configured for use in a wind turbine application. For example, a power converter can include an AC to DC converter coupled to a DC to AC converter. In an embodiment, the power converter can be a power converter configured for use in a solar application, a battery storage application, or an uninterruptible power supply application. For example, a power converter can be a DC to AC converter coupled to a DC power source, and configured to convert the DC power to an AC power for delivery to an AC grid. In another embodiment, the power converter can be a DC to DC power converter coupled to a DC power source and configured to condition or convert the DC power for delivery to a DC power source. In one or more embodiments, a filter device can be coupled between the power source and the power converter, and/or coupled between the converter and a power delivery point.

In this way, the systems and methods according to example aspects of the present disclosure can have a technical effect of allowing for reduced filter losses when filtering power from a power converter utilizing SiC MOSFETs. Further, this can allow for power converters utilizing SiC MOSFETs to be operated at higher switching frequencies than conventional power converters utilizing conventional IGBTs, while still allowing for the power output to be filtered to reduce harmonic frequencies from the power converter. Further, the systems and methods according to example aspects of the present disclosure can reduce the likelihood that a filter device, such as a filter inductor, will overheat when filtering power from a high-frequency power converter utilizing SiC MOSFETs. This can allow for increased operational reliability and decreased maintenance requirements.

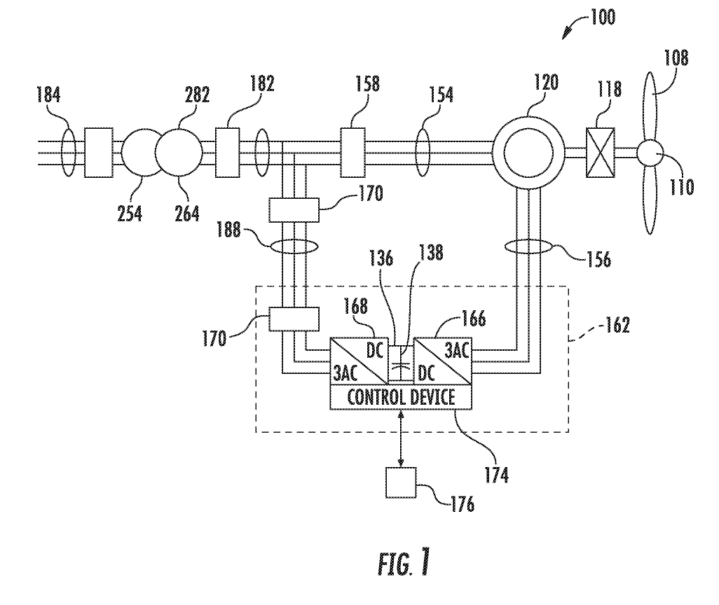

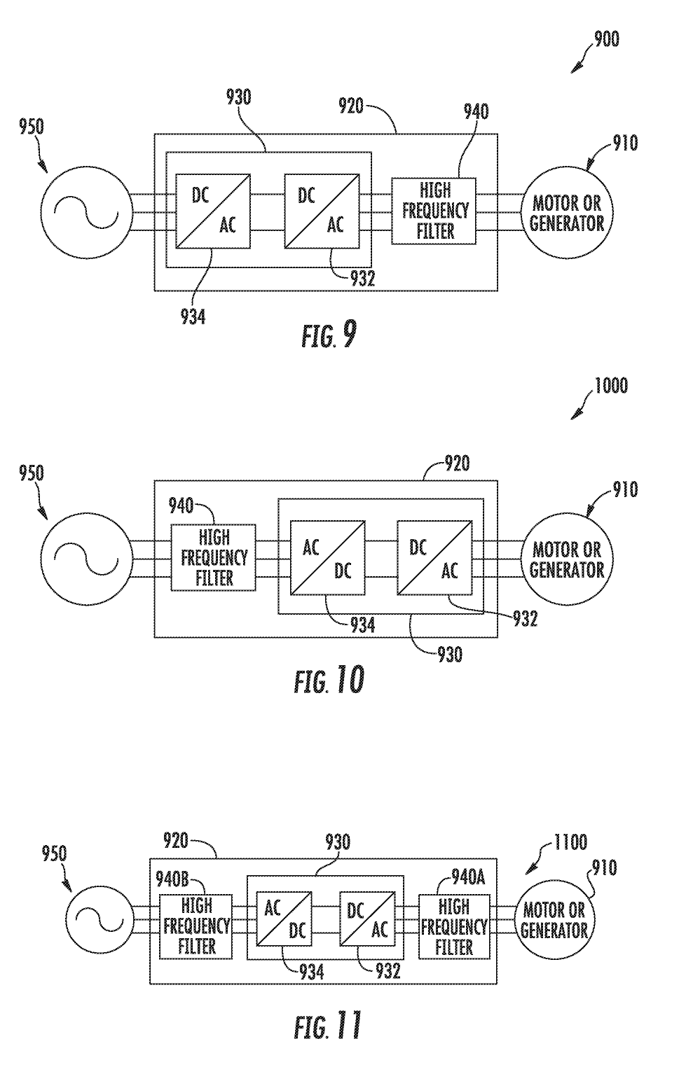

With reference now to the figures, example aspects of the present disclosure will be discussed in greater detail. FIG. 1 depicts a DFIG system 100 according to example aspects of the present disclosure. The present disclosure will be discussed with reference to the example DFIG 100 of FIG. 1 for purposes of illustration and discussion. Those of ordinary skill in the art, using the disclosures provided herein, should understand that aspects of the present disclosure are also applicable in other systems, such as solar power systems, energy storage systems, and uninterruptible power supply systems, as will be discussed in greater detail with reference to FIGS. 9-15.

In the example system 100, a rotor includes a plurality of rotor blades 108 coupled to a rotating hub 110, and together define a propeller. The propeller is coupled to an optional gear box 118, which is, in turn, coupled to a generator 120. In accordance with aspects of the present disclosure, the generator 120 is a doubly fed induction generator (DFIG) 120.

DFIG 120 is typically coupled to a stator bus 154 and a power converter 162 via a rotor bus 156. The stator bus provides an output multiphase power (e.g. three-phase power) from a stator of DFIG 120 and the rotor bus 156 provides an output multiphase power (e.g. three-phase power) of DFIG 120. The power converter 162 can be a bidirectional power converter configured to provide output power to the electrical grid 184 and/or to receive power from the electrical grid 184. As shown, DFIG 120 is coupled via the rotor bus 156 to a rotor side converter 166. The rotor side converter 166 is coupled to a line side converter 168 which in turn is coupled to a line side bus 188.

In example configurations, the rotor side converter 166 and/or the line side converter 168 are configured for normal operating mode in a three-phase, pulse width modulation (PWM) arrangement using SiC MOSFETs as switching devices. SiC MOSFETs can switch at a very high frequency as compared to conventional IGBTs. For example, SiC MOSFETs can be switched at a frequency from approximately 0.01 Hz to 10 MHz, with a typical switching frequency of 1 KHz to 400 KHz, whereas IGBTs can be switched at a frequency from approximately 0.01 Hz to 200 KHz, with a typical switching frequency of 1 KHz to 20 KHz. Additionally, SiC MOSFETs can provide advantages over ordinary MOSFETs when operated in some voltage ranges. For example, in power converters operating at 1200V-1700V on the LV side, SiC MOSFETs have lower switching losses than ordinary MOSFETs.

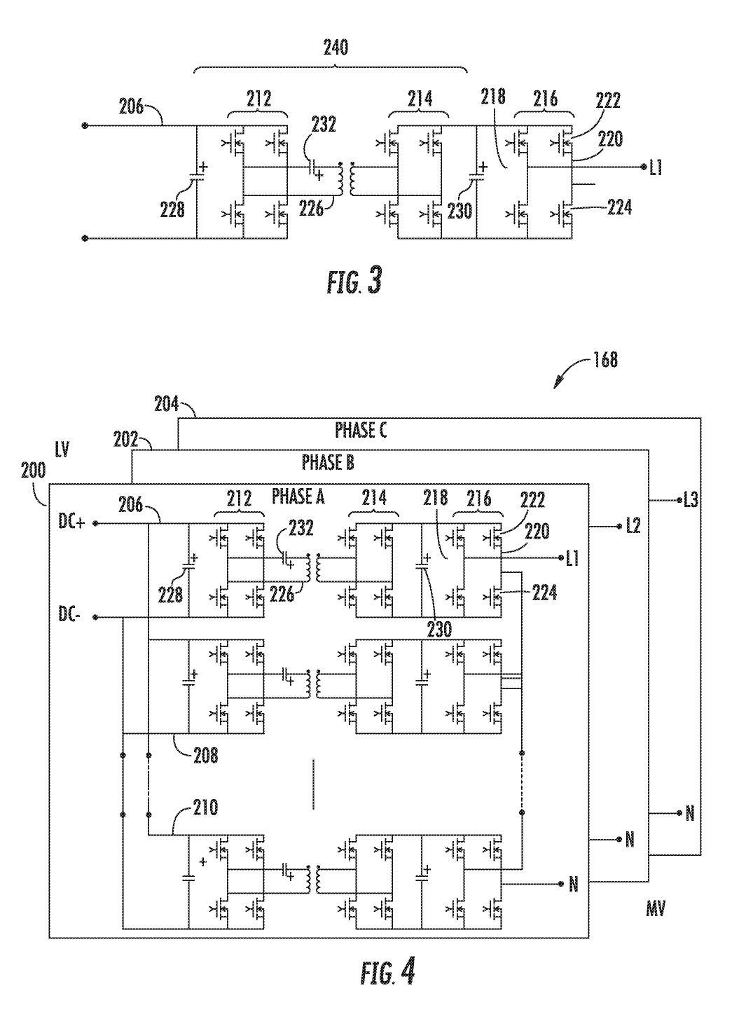

In some implementations, the rotor side converter 166 and/or the line side converter 168 can include a plurality of conversion modules, each associated with a an output phase of the multiphase power, as will be discussed in more detail with respect to FIG. 3. The rotor side converter 166 and the line side converter 168 can be coupled via a DC link 136 across which can be a DC link capacitor 138.

The power converter 162 can be coupled to a controller 174 to control the operation of the rotor side converter 166 and the line side converter 168. It should be noted that the controller 174, in typical embodiments, is configured as an interface between the power converter 162 and a control system 176.

In operation, power generated at DFIG 120 by rotating the rotor 106 is provided via a dual path to electrical grid 184. The dual paths are defined by the stator bus 154 and the rotor bus 156. On the stator bus side 154, sinusoidal multiphase (e.g. three-phase) is provided to the electrical grid. In particular, the AC power provided via the stator bus 154 can be a MV AC power. On the rotor bus side 156, sinusoidal multiphase (e.g. three-phase) AC power is provided to the power converter 162. In particular, the AC power provided to the power converter 162 via the rotor bus 156 can be a LV AC power. The rotor side power converter 166 converts the LV AC power provided from the rotor bus 156 into DC power and provides the DC power to the DC link 136. Switching devices (e.g. SiC MOSFETs and/or IGBTs) used in parallel bridge circuits of the rotor side power converter 166 can be modulated to convert the AC power provided from the rotor bus 156 into DC power suitable for the DC link 136. Such DC power can be a LV DC power.

Some DFIG systems 100 can include a three winding transformer 282 to couple the DFIG system 100 to the electrical grid 184. The three winding transformer 282 can have a medium voltage (e.g. greater than 12 KVAC) primary winding 254 coupled to the electrical grid 184, a medium voltage (e.g. 6 KVAC) secondary winding 254 coupled to the stator bus 158, and a low voltage (e.g. 575VAC, 690VAC, etc.) auxiliary winding 264 coupled to the line bus 188. The three winding transformer 282 arrangement can be preferred in increased output power systems (e.g. 3 MW systems) as it reduces the current in the stator bus 256 and other components on the stator side of the DFIG 120, such as a stator synch switch.

Such transformers can be used to increase the low voltage provided by the power converter 162 via the line bus 188 to a medium voltage suitable for output to the electrical grid 184.

Some DFIG systems 100 can include a power converter 162 to convert the LV power to MV AC power. For example, the line side converter 168 converts the LV DC power on the DC link 136 into a MV AC power suitable for the electrical grid 184. In particular, switching devices (e.g. SiC MOSFETs) used in bridge circuits of the line side power converter 168 can be modulated to convert the DC power on the DC link 136 into AC power on the line side bus 188. In addition, one or more isolation transformers coupled to one or more of the bridge circuits can be configured to step the voltage up or down as needed. A plurality of inverter blocks can be connected in series to build a MV AC voltage suitable for use on a MV AC grid. The MV AC power from the power converter 162 can be combined with the MV power from the stator of DFIG 120 to provide multiphase power (e.g. three-phase power) having a frequency maintained substantially at the frequency of the electrical grid 184 (e.g. 50 Hz/60 Hz). In this manner, the MV line side bus 188 can be coupled to the MV stator bus 154 to provide such multiphase power. In an embodiment, the line side converter 168 can include one or more SiC MOSFETs, which can be operated at a higher switching frequency than conventional IGBTs.

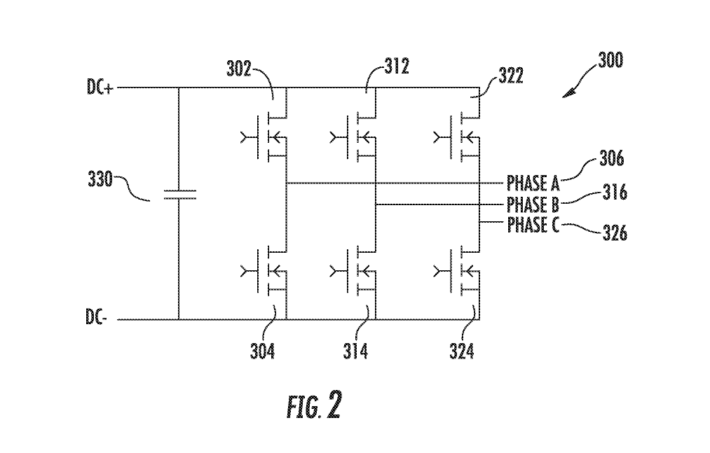

A filter device 170 can be included in a DFIG system 100. For example, a filter device 170 can be coupled between the power converter 162 and the electrical grid 184. For example, as depicted in FIG. 2, a filter device 170 is coupled to the line side bus 188 between the electrical grid 184 and the line side converter 168. Additionally, a filter device 170 can be included in a power converter 162. The filter device 170 can be a multiphase filter device, and/or each phase of the multiphase power from line side converter 168 can have a filter device 170. As will be discussed in greater detail with respect to FIGS. 5-8, the filter device 170 can be configured to filter out at least a portion of high frequency switching harmonics associated with silicon carbide MOSFETs in the power converter 162.

Various circuit breakers and switches, such as grid breaker 182, stator sync switch 158, etc. can be included in the system 100 for isolating the various components as necessary for normal operation of DFIG 120 during connection to and disconnection from the electrical grid 184. In this manner, such components can be configured to connect or disconnect corresponding buses, for example, when current flow is excessive and can damage components of the wind turbine system 100 or for other operational considerations. Additional protection components can also be included in the wind turbine system 100.

The power converter 162 can receive control signals from, for instance, the control system 176 via the controller 174. The control signals can be based, among other things, on sensed conditions or operating characteristics of the wind turbine system 100. Typically, the control signals provide for control of the operation of the power converter 162. For example, feedback in the form of sensed speed of the DFIG 120 can be used to control the conversion of the output power from the rotor bus 156 to maintain a proper and balanced multiphase (e.g. three-phase) power supply. Other feedback from other sensors can also be used by the controller 174 to control the power converter 162, including, for example, stator and rotor bus voltages and current feedbacks. Using the various forms of feedback information, switching control signals (e.g. gate timing commands for switching devices), stator synchronizing control signals, and circuit breaker signals can be generated.

Referring now to FIG. 2, an example topology of a power converter 300 according to example aspects of the present disclosure is depicted. This 2-level topology is capable of bidirectional power flow. Power converter 300 is a 2-level DC to AC converter, and can include a plurality of SiC MOSFETs. For example, power converter 300 can include 3 bridge circuits, one for each phase of a three phase power output, wherein each bridge circuit includes two SiC MOSFETs. As depicted in FIG. 2, a first bridge circuit can include a first SiC MOSFET 302 and a second SiC MOSFET 304 for phase A 306 of a three phase output, a second bridge circuit can include a third SiC MOSFET 312 and a fourth SiC MOSFET 314 for phase B 316 of a three phase output, and a third bridge circuit can include a fifth SiC MOSFET 322 and a sixth SiC MOSFET 324 for phase C 326 of a three phase output. The power converter 300 can further include a capacitor 330. Switching commands can be provided by a control system, such as a control system 176, to control the switching of the SiC MOSFETs to convert DC power to a three phase AC power. The SiC MOSFETs can switch at very high frequencies as compared to conventional IGBTs. Further, other suitable topologies can be used for a power converter in a power conversion system, such as the power converters and power converter components depicted in FIGS. 3 and 4.

Referring now to FIG. 3, a topology of a component in a DC to DC to AC converter is depicted. FIG. 3 depicts an example DC to DC to AC building block 206, which can be included in a conversion module 200 of a line side converter 168, as depicted in FIG. 4. Each building block 206 can include a plurality of conversion entities. For instance, building block 206 can include conversion entity 212, conversion entity 214, and conversion entity 216. Each conversion entity 212-216 can include a plurality of bridge circuits coupled in parallel. For instance, conversion entity 216 includes bridge circuit 218 and bridge circuit 220. As indicated, each bridge circuit can include a plurality of switching devices coupled in series. For instance, bridge circuit 220 includes an upper switching device 222 and a lower switching device 224. The switching devices can be SiC MOSFET switching devices, which can be operated at higher switching frequencies than conventional IGBTs. As shown, building block 206 further includes an isolation transformer 226. The isolation transformer 226 can be coupled to conversion entity 212 and conversion entity 214. As shown, the conversion branches can further include capacitors 228 and 230.

First conversion entity 212, isolation transformer 226, and second conversion entity 214 can together define an inner converter 240. Inner converter 240 can be operated to convert a LV DC power from the DC link 126 to a MV DC power. In an embodiment, inner converter 240 can be a high-frequency resonant converter. In a resonant converter configuration, a resonant capacitor 232 can be included in inner converter 240. In various embodiments, a resonant capacitor 232 can be included on a LV side of the isolation transformer 226 as depicted in FIG. 2, on an MV side of the isolation transformer 226 (not depicted), or on both the LV and MV sides of the isolation transformer 226 (not depicted). In another embodiment, inner converter 240 can be a hard-switched converter by removing the resonant capacitor 232. Third conversion entity 216 can also be referred to as an outer converter 216. Outer converter 216 can convert a MV DC power from the inner converter to a MV AC power suitable for use on an energy grid 184. In a typical application, outer converter 216 can be a hard-switched converter, and therefore not include a resonant capacitor.

FIG. 4 depicts an example line side converter 168 according to example embodiments of the present disclosure. As shown, the line side converter 168 includes conversion module 200, conversion module 202, and conversion module 204. The conversion modules 200-204 can be configured to receive a LV DC power from the rotor side converter 166, and to convert the LV DC power to a MV AC power for feeding to the electrical grid 184. Each conversion module 200-204 is associated with a single phase of three-phase output AC power. In particular, conversion module 200 is associated with the phase A output of the three-phase output power, conversion module 202 is associated with the phase B output of the three-phase output power, and conversion module 204 is associated with the phase C output of the three-phase output power.

Each conversion module 200-204 includes a plurality of building blocks 206-210. For instance, as shown, conversion module 200 includes building blocks 206, building block 208, and building block 210. In an embodiment, each conversion module 200-204 can include any number of building blocks 206-210. The line side converter 168 can be a bidirectional power converter. The line side converter 168 can be configured to convert a LV DC power to a MV AC power and vice versa. For instance, when providing power to the electrical grid 184, the line side converter 168 can be configured to receive a LV DC power from the DC link 136 on a LV side of the line side converter 168, and to output a MV AC power on a MV side of the line side converter 168. The module branches 206-210 can be coupled together in parallel on the LV side and can be coupled together in series on the MV side.

In one particular example implementation, when providing power to the electrical grid 184, the conversion entity 212 can be configured to convert the LV DC on the DC link 136 to a LV AC power. The isolation transformer 226 can be configured to provide isolation. The conversion entity 214 can be configured to convert the LV AC power to a LV DC power. The conversion entity 216 can be configured to convert the LV DC power to a LV AC power suitable for provision to the electric grid 184. A plurality of inverter blocks can be connected in series to build a MV AC voltage suitable for use on a MV AC energy grid.

The building blocks 206-210 can be configured to contribute to the overall MV AC power provided by the conversion module 200. In this manner, any suitable number of building blocks can be included within the building blocks 206-210. As indicated, each conversion module 200-204 is associated with a single phase of output power. In this manner, the switching devices of the conversion modules 200-204 can be controlled using suitable gate timing commands (e.g. provided by one or more suitable driver circuits) to generate the appropriate phase of output power to be provided to the electrical grid. For example, the controller 174 can provide suitable gate timing commands to the gates of the switching devices of the bridge circuits. The gate timing commands can control the pulse width modulation of the SiC MOSFETs and/or IGBTs to provide a desired output.

It will be appreciated, that although FIG. 4 depicts only the line side converter 168, the generator side converter 166 depicted in FIG. 2 can include a same or similar topology as the topology depicted in FIG. 4. In particular, the generator side converter 166 can include a plurality of conversion modules having one or more module branches as described with reference to the line side converter 168. Further, it will be appreciated that the line side converter 168 and the generator side converter 166 can include SiC MOSFET switching devices, IGBT switching devices, and/or other suitable switching devices. For instance, the line side generator 168 and/or the generator side converter 166 can include one or more SiC MOSFET switching devices and/or one or more IGBT switching devices. In implementations wherein the generator side converter 166 is implemented using SiC MOSFET switching devices, the generator side converter 166 can be coupled to a crowbar circuit (e.g. multiphase crowbar circuit) to protect the SiC MOSFET switching devices from high rotor current during certain fault conditions.

FIG. 5 depicts an example power conversion system 190 according to example aspects of the present disclosure. Elements that are the same or similar to those in FIG. 2 are referred to with the same reference numeral. As shown in FIG. 5, a filter device 170 can be coupled between a power converter 162 and a line side bus 188. The power converter 162 depicted in FIG. 5 can include a line side converter 168 and a rotor side converter 166. Other types of power converters 162 can be used with a filter device 170, as described herein. The power converter 162 can be operated with a relatively low fundamental frequency current, such as 50 to 60 Hz AC down to DC current, and also include high-frequency harmonic currents due to the high frequency switching of the SiC MOSFETs in the power converter 162. The SiC MOSFETs can provide an output power having a carrier frequency, modulated by a fundamental frequency, and a set of harmonic frequencies.

As depicted in FIG. 5, filter device 170 can include an inductor 171. Inductor 171 can be configured to filter and/or reduce harmonic current emissions from the power converter 162. The inductor 171 can include a low loss magnetic material in a core element of the inductor 171. For example, the core material can be a distributed gap material, such as powdered iron and ferrite. Further the core material can have multiple distributed air gaps in the core element. The inductor can further include a low loss coil element, which can be designed to reduce the resistance of the conductor at high-frequency. The inductor can form an L filter, which can be used in applications where reduction of the harmonic current emissions from the power converter 162 is required.

The filter device 170 can further include a capacitor. For example a first node of the inductor 171 can be coupled to the power converter 162. A second node of the inductor 171 can be coupled to a capacitor 172 which can further be connected to a ground. The second node of the inductor 171 can then be connected to a line side bus 188, as depicted in FIG. 5. While FIG. 5 depicts only a single filter device 170, one of ordinary skill in the art will recognize that each phase of a multiphase AC power converter can include a filter device 170 configured to filter high-frequency harmonics from the power converter 162 for each phase. For example, a first filter device 170 can filter first phase A, a second filter device 170 can filter a second phase B, and a third filter device 170 can filter a third phase C. The inductor 171 and capacitor 172 can together form an LC filter. The LC filter can receive the power output from the power converter 162 with a high voltage harmonic content and process the power by passing the fundamental frequency with minimal attenuation, while reducing the amplitude of the harmonic frequencies. The LC filter can be used in applications where more significant harmonic current attenuation is required than is provided by the L filter.

In an embodiment, a filter device 170 can include a plurality of inductors 170. For example, a filter device 170 can include a plurality of inductors 171 coupled in series. Additionally and/or alternatively, a filter device 170 can include a plurality of inductors 171 coupled in parallel. In an embodiment, a power conversion system 190 can include a plurality of filter devices 170, such as a filter device 170 coupled on each side of a power converter 162.

The power conversion system 190 can further include a cooling system 173. The cooling system 173 can be configured to cool the inductor 171 of a filter device 170. For example, in an embodiment, the cooling system 173 can be configured to cool the inductor 171 and/or capacitor 172 of a filter device 170 by convection. The cooling system can include, for example, one or more heatsinks or other convection cooling devices coupled to the inductor 171. The convection cooling device can be configured to dissipate heat in the inductor 171 by convection. In another embodiment, the cooling system 173 can include a fan cooling system, such as one or more electric fans configured to direct an airflow over the inductor 171 to allow the airflow to provide cooling to the inductor 171. In another embodiment, the cooling system 173 can include a liquid cooling system, such as a water-based liquid cooling system configured to circulate a cooling liquid over the inductor 171 to allow for heat transfer to occur from the inductor 171 into the cooling liquid, which can then be routed to a heat extractor which can remove the heat from the cooling liquid, thereby allowing the cooling liquid to be recirculated to the inductor 171 to provide further cooling. In yet another embodiment, the cooling system 173 can be an evaporative cooling system, wherein the evaporative cooling system is configured to provide a phase change fluid to the inductor 171. As the phase change fluid changes phases, such as from a liquid to a gas, the phase change fluid can remove heat from the inductor 171, thereby providing cooling. One of ordinary skill in the art will recognize that any number of cooling systems 173 can similarly be used to cool the inductor 171 and/or capacitor 172 of a filter device 170.

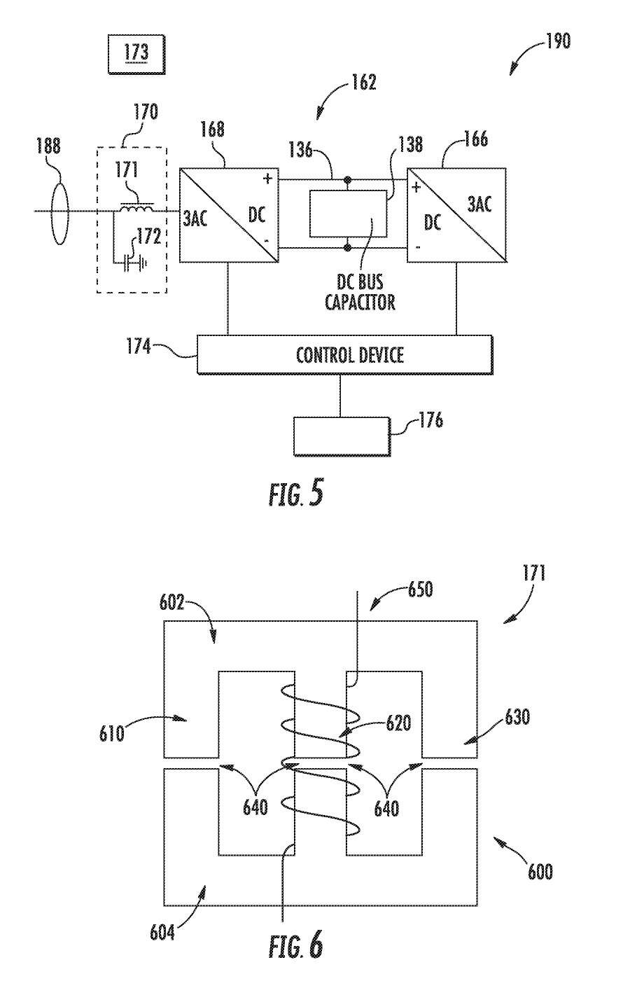

Referring now to FIG. 6, an inductor 171 according to example aspects of the present disclosure is shown. As shown in FIG. 6, an inductor 171 can be configured in a cut E-core configuration. For example, an inductor 171 can include a core element 600, which can include two core halves 602 and 604. The first core half 602 and second core half 604 can be arranged such that the two core halves 602 and 604 form a first leg 610, a second leg 620, and a third leg 630. Between the first core half 602 and second core half 604 can be multiple air gaps 640 separating the two halves of first leg 610, second leg 620, and third leg 630.

The core element 600 can be made of a low loss magnetic core material. The core element 600 can include multiple distributed air gaps in the core, such as air gaps 640. The air gaps 640 can be arranged in any number of configurations. For example, a first leg 610 can include an air gap 640 of a first size, a second leg 620 may not have an air gap at all, and a third leg 630 can include a second air gap 640 of a second size. One of ordinary skill in the art will recognize that any number of air gap configurations can be used to tune the reluctance of the inductor 171. The core element 600 can also be made of a core material with a distributed gap in the core material itself. For example, the core element 600 can be made of powdered iron and ferrite. In an embodiment, the core element 600 can be made of finely ground magnetic material where the magnetic particles are coated with non-conducting and non-magnetic layers.

The inductor 171 can further include a coil element 650. For example, as shown in FIG. 6, a coil element 650 is coiled about a portion of the core element 600, which is the second leg 620. One of ordinary skill in the art will recognize that the coil element 650 can be coiled about portion of the core element 600, such as first leg 610 or third leg 630. The coil element 650 can be a low loss conductor or configuration of current carrying conductors, and can be designed to reduce the resistance of the inductor 171 at high-frequency, commonly known as RAC/RDC. For example, the coil element 650 can be made of thin layers of foil, small parallel wires, continuously transposed parallel conductors (“CTC”), or Litz wire. Litz wire, for example, can be made of a plurality of thin wire strands, wherein each individual strand is insulated, and the plurality of individual wire strands are twisted or woven together.

The inductor 171 can be used to receive power output from a power converter 162 and process the power by passing the fundamental frequency with minimal attenuation while reducing the amplitude of the harmonic frequencies from the power converter 162.

Referring now to FIG. 7, another inductor 171 according to additional aspects of the present disclosure is depicted. As shown in FIG. 7, an inductor 171 can be configured in a cut C-core configuration. For example, an inductor 171 can include a core element 600 which can include two core halves 602 and 604. The first core half 602 and second core half 604 can be arranged such that the two core have 602 and 604 form a first leg 610 and a second leg 620. Between the first core half 602 and second core half 604 can be multiple air gaps 640 separating the two halves of first leg 610 and second leg 620.

Similar to the inductor 171 depicted in FIG. 6, the inductor 171 depicted in FIG. 7 can utilize a low loss magnetic core material, with multiple distributed air gaps in the core element 600. Further, the core material of the core element 600 can include a distributed gap in the core material itself. For example, the core element 600 can include finely ground magnetic material where the magnetic particles are coated with non-conducting and non-magnetic layers. Additionally, the coil element 650 can be made of a low loss conductor or configuration of current carrying conductors, which can be designed to reduce the resistance of the coil element at high-frequency. For example, the coil element 650 can be made of thin layers of foil, small parallel wires, CTC, or Litz wire. As shown in FIG. 7, the coil element 650 can be coiled about a portion of the core element 600, such as second leg 620.

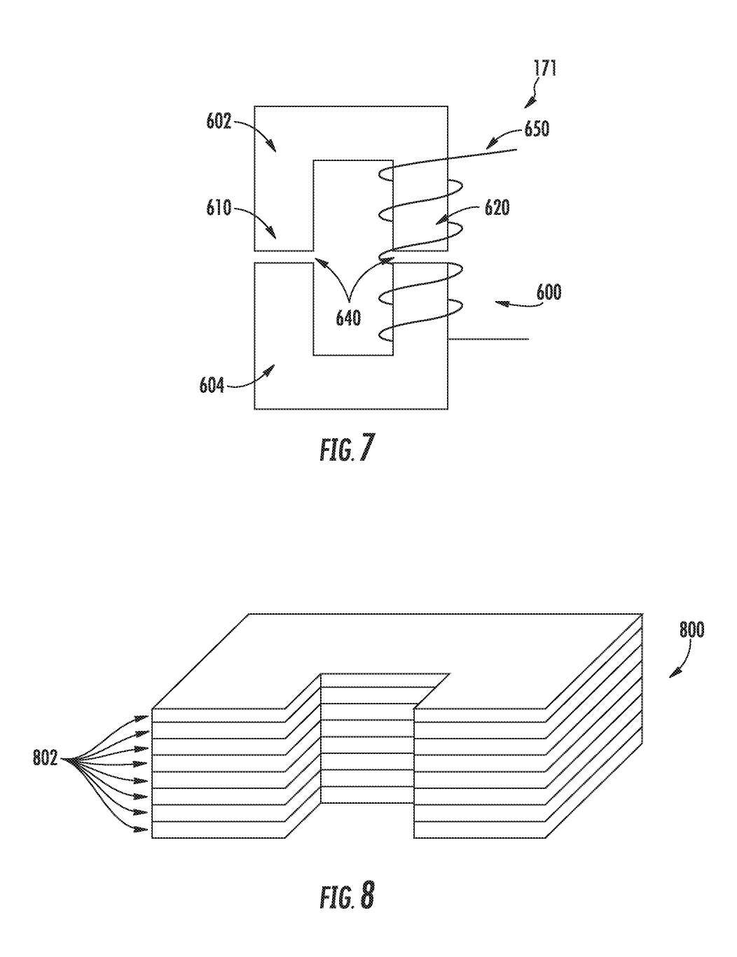

Referring now to FIG. 8, a core element 800 according to additional aspects of the present disclosure is depicted. Core element 800 can be, for example, a portion of a core element 600, such as first core half 602 of a cut C-core as depicted in FIG. 7. One of ordinary skill in the art will recognize that core element 800 could similarly be configured in any number of core element configurations, such as cut S-cores, wound type laminated unicores, or any other laminated inductor core element. Further, the laminated layers 802 can be arranged with multiple air gaps, such as staggered air gaps wherein the air gaps of individual laminated layers 802 do not necessarily align with the air gaps of other laminated layers 802 in the core element 800. As shown in FIG. 8, a core element 800 can include a plurality of laminated layers 802. For example, core element 800, as depicted, includes eight laminated layers 802. One of ordinary skill in the art will recognize that any number of laminated layers 802 can be included in a core element 800. Each laminated layer 802 can be made of a magnetic material coated with a non-magnetic and non- conducting material. Together, the plurality of laminated layers 802 can comprise a core element for use in an inductor 171, or a portion thereof.

Referring generally to FIGS. 5-8, any of the filters and/or filter components depicted herein can be configured to filter out at least a portion of one or more switching harmonics associated with one or more silicon carbide MOSFETs in a power converter, such as a power converter 162.

Referring now to FIG. 9, a power system 900 according to example aspects of the present disclosure is depicted. The power system 900 can include a motor/generator 910. For example, motor/generator 910 can be a motor drive configured to receive AC power and provide a mechanical output using the AC power. Additionally and/or alternatively, motor/generator 910 can be a generator, such as a DFIG, configured to generate an AC power using a mechanical power input. Power system 900 can further include a power conversion system 920. For example, power conversion system 920 can include a power converter 930 and a filter device 940. Power converter 930 can include a first converter 932 which can be an AC to DC converter, and a second converter 934 which can be a DC to AC converter. For example, first converter 932 can be a two-level or multi-level power converter, and can correspond to generator side converter 166. Second converter 934 can be, for example, a DC to DC to AC converter, such as line side converter 168 depicted in FIG. 4. First and second converters 932 and 934 can be other types of AC to DC and DC to AC converters. Power converter 930 can include a plurality of SiC MOSFETs. Power converter 930 can correspond to power converter 162, as described herein. Filter device 940 can be a high-frequency filter configured to filter high-frequency harmonics from power converter 930. For example, filter device 940 can be a filter device 170 as described herein. Power system 900 can further include a distribution network 950, such as an AC network. For example, distribution network 950 can correspond to grid 184 as discussed herein.

In an embodiment, motor/generator 910 can provide AC power to power conversion system 920. Filter device 940 can filter the high-frequency harmonics from the AC power provided by motor/generator 910 and provide the filtered AC power to the first converter 932. First converter 932 can convert the filtered AC power to DC power and provide the DC power to second converter 934. Second converter 934 can convert the DC power to AC power and provide the AC power to AC network 950. In this way, harmonics from the motor/generator 910 can be filtered before power is provided to distribution network 950.

In an embodiment, distribution network 950 can provide AC power to power conversion system 920. For example AC power can be provided by AC network 952 second converter 934 which can convert the AC power to DC power. The DC power can be provided to first converter 932 which can convert the DC power to AC power. The AC power and then be provided to filter device 940 which can filter high-frequency harmonics from the AC power. The filtered AC power can then be provided to power motor/generator 910. In this way, filtered power can be provided to a motor/generator 910.

Referring now to FIG. 10, a power system 1000 according to additional aspects of the present disclosure is depicted. Elements that are the same as those in FIG. 9 are referred to with the same reference numerals. As shown, power system 1000 is very similar to power system 900, with the only difference being that the filter device 940 is now located on the distribution network 950 side of power conversion system 920 as opposed to the motor/generator 910 side, as depicted in FIG. 9. Thus, AC power provided by distribution network 950 can first be filtered by filter device 950 before being converted by power converter 930 and provided to motor/generator 910. Additionally, power provided by motor/generator 910 can first be provided to the power converter 930, which can convert the power and provide the converted power to filter device 940 which can then filter the converted power and provide the filtered power to distribution network 950.

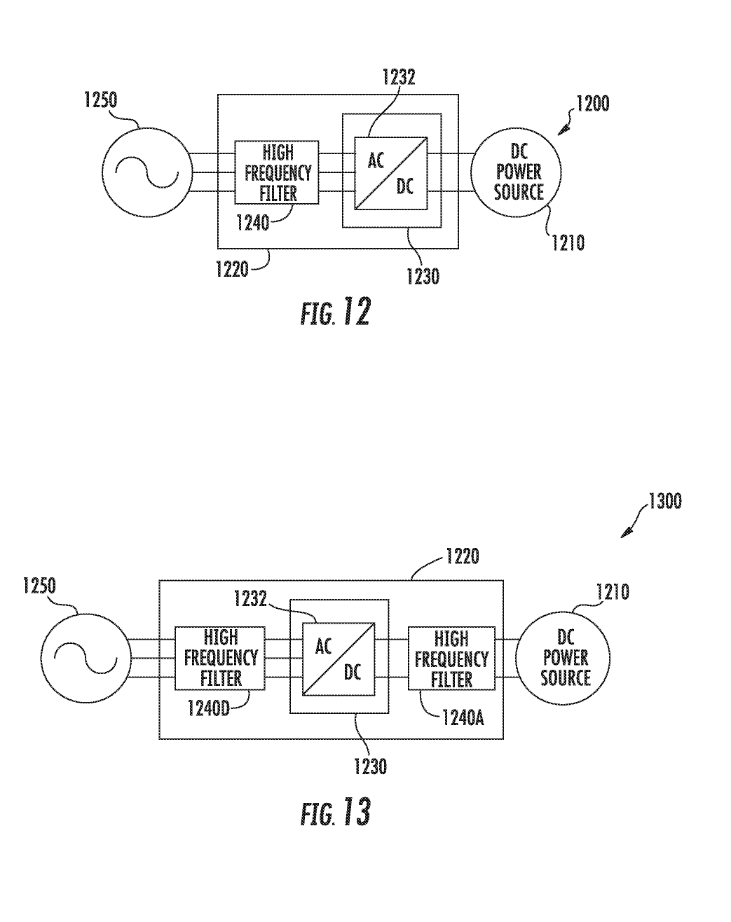

Referring now to FIG. 11, a power system 1100 according to additional aspects of the present disclosure is depicted. Elements are the same as those in FIGS. 9-10 are referred to with the same reference numerals. As shown, a power system 1100 is very similar to power systems 900 and 1000, with the only difference being that power conversion system 920 includes a first filter device 940A between power converter 930 and motor/generator 910, and a second filter device 940B located between power converter 930 and distribution network 950. Thus, power provided to or from distribution network 950 can be filtered by filter device 940B, and power provided to or from motor/generator 910 can be filtered by filter device 940A.

Referring now to FIG. 12, a power system 1200 according to example aspects of the present disclosure is depicted. The power system 1200 can include a DC power source 1210. For example, DC power source 1210 can be a solar device, such as a photo-voltaic cell or array of photo-voltaic cells, an energy storage device, such as a battery, capacitor, or supercapacitor, or an uninterruptible power supply. Power system 1200 can further include a power conversion system 1220. DC power source 1210 can be configured to provide DC power to power conversion system 1220, which can convert the DC power. For example, power conversion system 1220 can include a power converter 1230 and a filter device 1240. Power converter 1230 can include a first converter 1232 which can be a DC to AC converter. For example, first converter 1232 can be a two-level or multi-level power converter, and can correspond to generator side converter 166. First converter 1232 can also be, for example, a DC to DC to AC converter, such as line side converter 168 depicted in FIG. 4. First converter 1232 can be other types of AC to DC/DC to AC converters as well. Power converter 1230 can include a plurality of SiC MOSFETs. Power converter 1230 can correspond to a portion of power converter 162, as described herein. Filter device 1240 can be a high-frequency filter configured to filter high- frequency harmonics from power converter 1230. For example, filter device 1240 can be a filter device 170 as described herein. Power system 1200 can further include a distribution network 1250, such as an AC network. For example, distribution network 1250 can correspond to grid 184 as discussed herein.

In an embodiment, DC power source 1210 can provide DC power to power conversion system 1220. First converter 1232 of power converter 1230 can convert the DC power to AC power and provide the AC power to filter device 1240. Filter device 1240 can then filter the AC power and provide the filtered AC power to distribution network 1250. In this way, harmonics from the power converter 1230 can be filtered before AC power is provided to distribution network 1250.

In an embodiment, distribution network 1250 can provide AC power to power conversion system 1220. For example AC power can be provided by distribution network 1250 to filter device 1240, which can filter harmonics from the AC power before providing power to power converter 1230. Power converter 1230 can then convert the filtered AC power to DC power, and provide the converted DC power to DC power source 1210, which can store the DC power. In this way, AC harmonics from distribution network 1250 can be filtered before AC power is provided to power converter 1230.

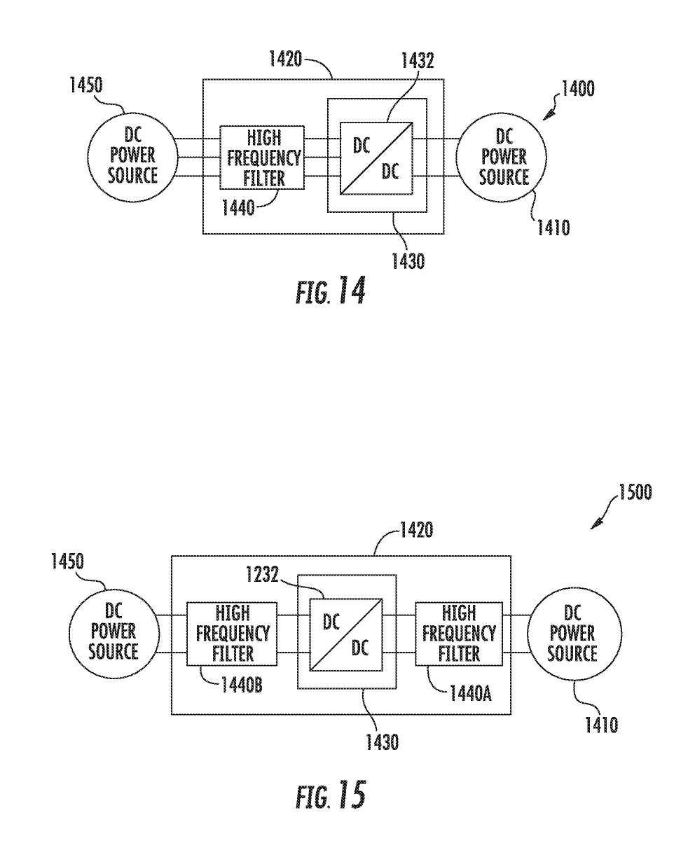

Referring now to FIG. 13, a power system 1300 according to additional aspects of the present disclosure is depicted. Elements that are the same as those in FIG. 12 are referred to with the same reference numerals. As shown, a power system 1300 is very similar to power system 1200, with the only difference being that power conversion system 1220 includes a first filter device 1240A between power converter 1230 and DC power source 1210, and a second filter device 1240B located between power converter 1230 and distribution network 1250. Thus, power provided to or from distribution network 1250 can be filtered by filter device 1240B, and power provided to or from DC power source 1210 can be filtered by filter device 1240A.

Referring now to FIG. 14, a power system 1400 according to example aspects of the present disclosure is depicted. The power system 1400 can include a first DC power source 1410. For example, first DC power source 1410 can be a solar device, an energy storage device, such as a battery, capacitor, or supercapacitor, or an uninterruptible power supply. Power system 1400 can further include a power conversion system 1420. First DC power source 1410 can be configured to provide DC power to power conversion system 1420, which can convert the DC power. For example, power conversion system 1420 can include a power converter 1430 and a filter device 1440. Power converter 1430 can include a first converter 1432 which can be a DC to DC converter, such as a power conditioner or DC to DC converter configured to convert a voltage of the DC power. Power converter 1430 can include a plurality of SiC MOSFETs. Power converter 1430 can correspond to a portion of power converter 162, as described herein. Filter device 1440 can be a high-frequency filter configured to filter high-frequency harmonics from power converter 1430. For example, filter device 1440 can be a filter device 170 as described herein. Power system 1400 can further include a second DC power source 1450. For example, second DC power source 1450 can be a solar device, an energy storage device, such as a battery, capacitor, or supercapacitor, or an uninterruptible power supply.

In an embodiment, DC power source 1410 can provide DC power to power conversion system 1420. First converter 1432 of power converter 1430 can convert the DC power to DC power and provide the converted DC power to filter device 1440. Filter device 1440 can then filter the converted DC power and provide the filtered DC power to second DC power source 1450. In this way, harmonics from the power converter 1430 can be filtered before DC power is provided to second DC power source 1450.

In an embodiment, second power source 1450 can provide DC power to power conversion system 1220. For example DC power can be provided by second DC power source 1450 to filter device 1440, which can filter harmonics from the DC power before providing power to power converter 1430. Power converter 1430 can then convert the filtered DC power to converted DC power, and provide the converted DC power to DC power source 1210, which can store the DC power. In this way, harmonics from second DC power source 1450 can be filtered before DC power is provided to power converter 1430.

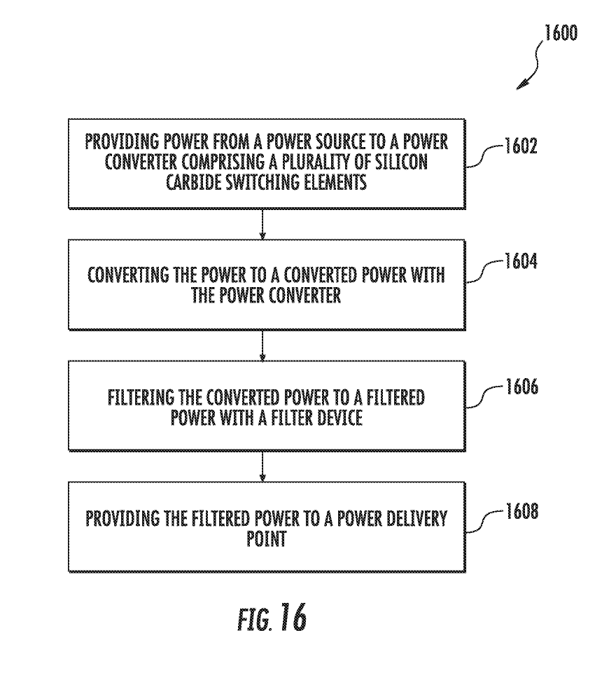

Referring now to FIG. 15, a power system 1500 according to additional aspects of the present disclosure is depicted. Elements that are the same as those in FIG. 14 are referred to with the same reference numerals. As shown, a power system 1500 is very similar to power system 1400, with the only difference being that power conversion system 1420 includes a first filter device 1440A between power converter 1430 and first DC power source 1210, and a second filter device 1440B located between power converter 1430 and second DC power source 1450. Thus, power provided to or from second DC power source 1450 can be filtered by filter device 1440B, and power provided to or from first DC power source 1410 can be filtered by filter device 1440A.

Referring now to FIG. 16, a method (1600) for providing power according to example aspects of the present disclosure is depicted. At (1602), the method (1600) can include providing power from a power source to a power converter comprising one or more silicon carbide switching elements. For example, the power source can be an AC power source, such as a DFIG or an AC network, or a DC power source, such as a solar device, an energy storage system, such as a battery, capacitor, or super capacitor, or an uninterruptible power supply. The power converter can be, for example, an AC to AC power converter, a DC to DC power converter, an AC to DC power converter, a DC to AC power converter, or a DC to DC to AC power converter, as described herein. The power converter can include one or more silicon carbide switching elements, such as SiC MOSFETs. For example, the power converter can be a high-frequency power converter utilizing SiC MOSFETs operating at a relatively low fundamental frequency, such as 50 to 60 Hz down to DC. The SiC MOSFETs of the power converter can provide an output power having a carrier frequency modulated by a fundamental frequency and a set of harmonic frequencies. Other power converters can similarly be used. Further, a power converter can include multiple converters, such as a first converter and a second converter, as described herein.

At (1604), the method (1600) can include converting the power to a converted power with the power converter. For example, a power converter can convert a DC power to an AC power using a DC to DC to AC power converter. The converted power can have a carrier frequency modulated by a fundamental frequency, and a set of harmonic frequencies.

At (1606), the method (1600) can include filtering the converted power to a filtered power with a filter device. For example, a filter device can be a filter device 170 which can include an inductor 171 and a capacitor 172. The filter device 170 can be configured to filter the high-frequency harmonics from the converted power. For example, the filter device 170 can include an inductor with a low loss magnetic core and a low loss coil element designed to reduce the resistance of the inductor at high frequencies, which can filter the harmonic frequencies.

At (1608), the method (1600) can include providing the filtered power to a power delivery point. For example, a power delivery point can be an AC grid 184. The converted and filtered power can be provided by a filter device, such as a filter device 170, to an AC grid 184. Other power delivery points can similarly be used, such as energy storage devices, motors, or other power delivery points. In this way, the method (1600) can be used to provide a filtered, converted power to a power delivery point.

The present disclosure is discussed with reference to filter devices for use in a power system including a power converter utilizing SiC MOSFETs, for purposes of illustration and discussion. Those of ordinary skill in the art, using the disclosures provided herein, will understand that the filter devices according to aspects of the present disclosure can be used with many types of power systems and/or topologies. For instance, the filter devices can be used in a wind, solar, gas turbine, or other suitable power generation system. Further, one of ordinary skill in the art will recognize that filter devices according to example aspects of the present disclosure, such as filter devices depicted in FIGS. 5-8 can be used to filter high frequency switching harmonics associated with silicon carbide MOSFETs in a power converter. Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A power conversion system, comprising:
a power converter configured to convert power from a first power to a second power, wherein the second power has at least one different characteristic from the first power, the power converter comprising one or more silicon carbide MOSFETs; and
a filter device comprising an inductor, the filter device configured to filter out at least a portion of one or more switching harmonics associated with the one or more silicon carbide MOSFETs from the second power converted by the power converter;
wherein the inductor comprises a laminated core, the laminated core comprising a plurality of laminated layers, wherein each layer of the plurality of laminated layers comprises a magnetic material coated with a non-magnetic and non-conducting material.

2. The power conversion system of claim 1, wherein the inductor further comprises a coil element, wherein the coil element comprises a conductor coiled around at least a portion of the laminated core.

3-5. (canceled)

6. The power conversion system of claim 2, wherein the coil element comprises at least one of parallel wires, continuously transposed parallel conductors, Litz wire, or layers of foil.

7. The power conversion system of claim 2, further comprising a cooling system configured to cool the filter device.

8. The power conversion system of claim 7, wherein the cooling system comprises one of a convective cooling system, a fan cooling system, a liquid cooling system, or an evaporative cooling system.

9. The power conversion system of claim 2, wherein the filter device comprises a plurality of inductors, each inductor comprising the coil element and the laminated core.

10. The power conversion system of claim 9, wherein the plurality of inductors are coupled in series.

11. The power conversion system of claim 9, wherein the plurality of inductors are coupled in parallel.

12. The power conversion system of claim 2, wherein the filter device further comprises a capacitor.

13. The power conversion system of claim 1, wherein the power converter comprises a two-level or multi-level power converter.

14. The power conversion system of claim 1, wherein the power converter comprises a power converter for a wind turbine, motor drive, solar, energy storage, or uninterruptable power supply application.

15. The power conversion system of claim 1, wherein the at least one different characteristic of the second power comprises at least one of a difference in voltage, a conversion from a first alternating current power to a second alternating current power, a conversion from a first direct current power to a second direct current power, a conversion from alternating current power to direct current power, or a conversion from direct current power to alternating current power.

16. A method for providing power, comprising:
providing power from a power source to a power converter, the power converter configured to convert power from a first power to a second power, the second power having at least one different characteristic from the first power, the power converter comprising one or more silicon carbine MOSFETs;
converting the power with the power converter to a converted power;
filtering the converted power to a filtered power with a filter device comprising an inductor, the filter device configured to filter at least a portion of one or more switching harmonics from the converted power; and
providing the filtered power to a power delivery point,
wherein the inductor comprises a laminated core, the laminated core comprising a plurality of laminated layers, wherein each layer of the plurality of laminated layers comprises a magnetic material coated with a non-magnetic and non-conducting material.

17. The method of claim 16, wherein the inductor further comprises a coil element, wherein the coil element comprises a conductor coiled around at least a portion of the laminated core.

18. The method of claim 17, wherein the filter device further comprises a capacitor.

19. The method of claim 16, wherein the power source comprises one of a wind turbine, a solar power source, a distribution network, an energy storage device, or an uninterruptable power supply.

20. A wind turbine power system, comprising:
a wind driven generator configured to generate AC power;
a power converter coupled to the generator, the power converter comprising a first converter configured to convert AC power to DC power and a second converter configured to convert DC power to AC power, the second converter comprising one or more silicon carbide MOSFETs; and
a filter device comprising an inductor, the filter device configured to filter at least a portion of one or more switching harmonics from power converted by the second power converter;
wherein the inductor comprises a laminated core, the laminated core comprising a plurality of laminated layers, wherein each layer of the plurality of laminated layers comprises a magnetic material coated with a non-magnetic and non-conducting material.
